(19) United States
(12) Patent Application Publication
(10) Pub. No.: US 2014/0214465 A1
(43) Pub. Date: Jul. 31, 2014

(54) PROCESSING RESTAURANT ORDERS WITHIN COMPUTING SYSTEMS

(71) Applicants: Israel L'Heureux, Monaco (MC); Mark D. Alleman, Portland, OR (US)

(72) Inventors: Israel L'Heureux, Monaco (MC); Mark D. Alleman, Portland, OR (US)

(21) Appl. No.: 13/481,807

(22) Filed: May 26, 2012

(51) Int. Cl. G06Q 10/06; G06Q 50/12

(52) U.S. Cl. 705/7.13

(57) ABSTRACT

An order initiated by a customer via a client device is received over a communications network. The order indicates a target restaurant of a plurality of available restaurants having diverse menus, a delivery location, and a food order including one or more menu items available at the target restaurant. The food order is directed to one or more workstations of the target restaurant for presentation via an order-fulfillment interface to staff responsible for preparation of the one or more menu items. A delivery task is directed to a different client device for presentation via a delivery-fulfillment interface to a delivery agent responsible for delivery of the food order to the delivery location. The delivery task indicates the delivery location.

### BACKGROUND

Restaurants serve customers located both on-premises, and at remote delivery locations using delivery agents. Food orders may be received by restaurants through in-person communications from customers located on-premises, and by telephone, fax, or email for customers located off-premises. A customer located off-premises typically places an order with the restaurant that is responsible for preparing the food order by using the restaurant's direct telephone number, fax number, or email address.

### SUMMARY

An order initiated by a customer via a client device is received over a communications network. The order indicates a target restaurant of a plurality of available restaurants having diverse menus, a delivery location, and a food order including one or more menu items available at the target restaurant. The food order is directed to one or more workstations of the target restaurant for presentation via an order-fulfillment interface to staff responsible for preparation of the one or more menu items. A delivery task is directed to a different client device for presentation via a delivery-fulfillment interface to a delivery agent responsible for delivery of the food order to the delivery location. The delivery task indicates the delivery location.

This Summary presents only a small selection of the various concepts described in further detail by the Detailed Description and associated drawings, and is not intended to be used to limit the scope of the claimed subject matter.

### BRIEF DESCRIPTION OF DRAWINGS

FIG. 1 is a schematic diagram depicting an example use-environment, including an example computing system.

FIG. 2 is a flow diagram depicting an example method for processing a restaurant order.

FIG. 3 is a schematic diagram depicting an example computing device.

### DETAILED DESCRIPTION

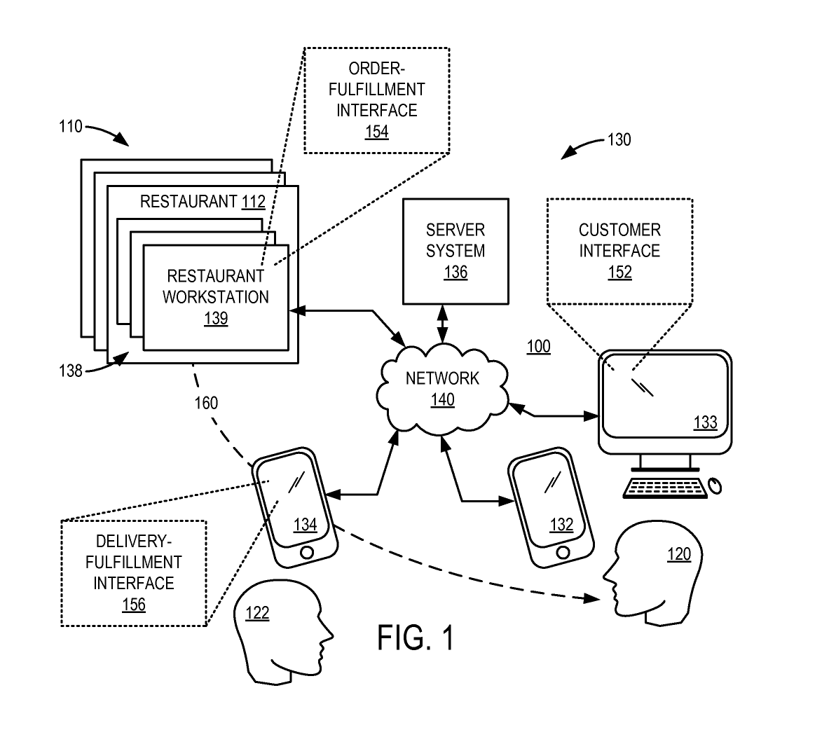

FIG. 1 is a schematic diagram depicting an example use-environment 100. Use-environment 100 includes a plurality of restaurants 110 with which customers, such as example customer 120 may place an order with a target restaurant 112 for the preparation and/or delivery of food items. Restaurants 110 may be geographically remote from each other and may have diverse menus.

Within use-environment 100, orders placed by customers may be processed by a computing system 130 that includes one or more computing devices, such as client devices 132, 133, 134, a server system 136 including one or more sever devices, and one or more restaurant workstations 138. These computing devices may communicate with each other over a communications network 140. Restaurants 110 may be made available to customer 120 over communications network 140 via a customer interface 152 presented at a client device operated by the customer, such as wireless mobile client device 132 or other suitable client device 133.

Server system 136 may be configured to receive an order over communications network 140 initiated by customer 120 via customer interface 152 presented at a client device. Responsive to receiving the order, server system 136 may be configured to direct information to one or more workstations 138 of a target restaurant 112 and/or to a client device 134 of a delivery agent 122. As one example, food orders may be presented via an order-fulfillment interface 154 of a workstation 139 to restaurant staff responsible for preparation of one or more menu items. As another example, a delivery task, including an indication of a delivery location may be presented via a delivery-fulfillment interface 156 of client device 134 to delivery agent 122 that is responsible for delivery 160 of the food order to the delivery location.

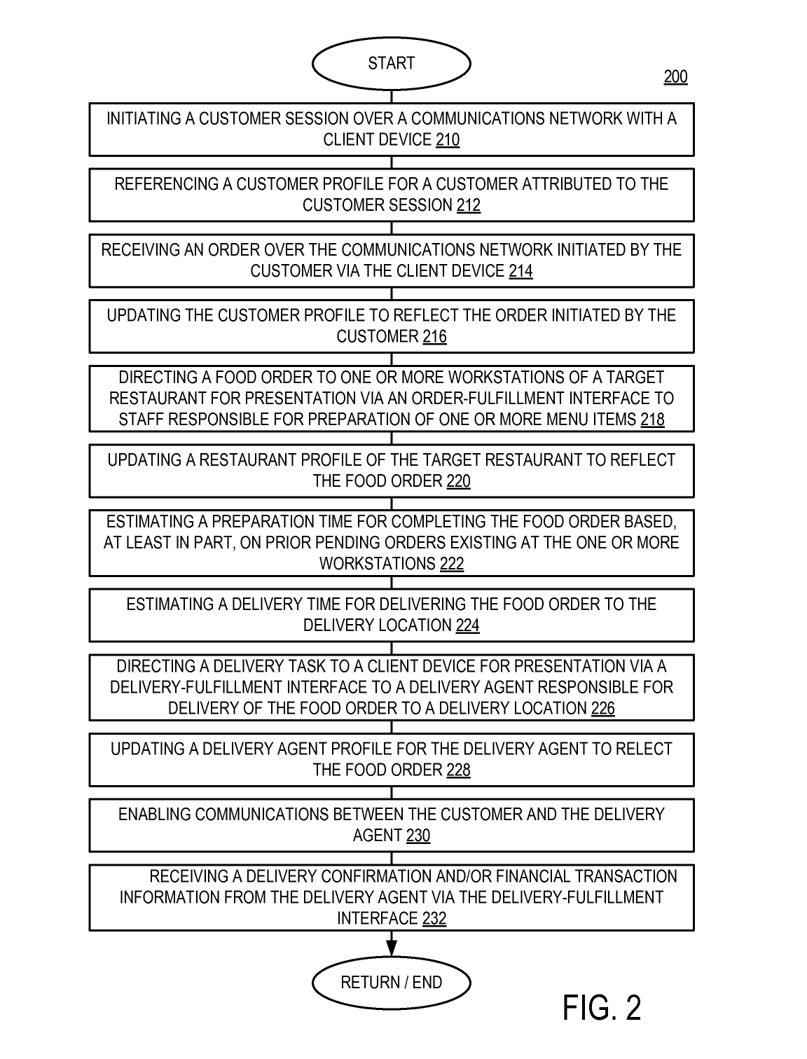

FIG. 2 is a flow diagram depicting an example method 200 for processing a restaurant order. As one example, method 200 may be performed by a server system, such as previously described server system 136 of FIG. 1. A server system or other suitable computing device configured to perform method 200 may reside at any suitable network location, including on-premises of a restaurant or off-premises in a remote data center. Such a server system may be distributed across one or more computing devices that are geographically remote from each other.

At 210, the method may include initiating a customer session over a communications network with a client device operated by a customer. The customer session may be initiated responsive to a customer navigating to a network resource (e.g., a URL), logging-in via a customer interface, and/or launching an application program supporting the customer interface.

At 212, the method may include referencing a customer profile for a customer attributed to the customer session. The customer profile may reside at a database and may be referenced within the database using a customer identifier. The customer identifier may be supplied by the customer via the customer interface as part of a registration process, a login process, and/or may be identified from a software and/or hardware identifier corresponding to the software application and/or client device from which the customer accesses the customer session.

At 214, the method may include receiving an order over the communications network initiated by the customer via the client device. The order may indicate one or more of a target restaurant, a delivery location, and a food order including one or more menu items available at the target restaurant. The delivery location may be indicated by geo-location of the client device that initiated the order, or the delivery location may be obtained from a customer profile as described in greater detail with reference to the method at 216.

At 216, the method may include updating the customer profile at a database to reflect the order initiated by the customer. For example, information indicating one or more of the target restaurant, the delivery location, and/or the food order may be stored in the customer profile of the customer for each session. Such information may be subsequently referenced from the customer profile to process the order received at 214 and/or to process subsequent orders received from the customer as part of subsequent customer sessions. Such information may be used to provide menu recommendations to customers based on prior orders, to provide delivery location information to delivery agents, and/or to facilitate financial transactions based on the customer's financial information stored in the customer profile.

At 218, the method may include directing the food order to one or more workstations of the target restaurant for presentation via an order-fulfillment interface to staff responsible for preparation of the one or more menu items. If the restaurant includes multiple workstations, the method at 218 may include directing a first subset of the food order to a first workstation of the target restaurant responsible for preparation of a first food component of the one or more menu items, and directing a second subset of the food order to a second workstation of the target restaurant responsible for preparation of a second food component of the one or more food items. Workstations may be associated with workstation identifiers within a database to enable multiple workstations within an individual restaurant to be distinguished from each other. Workstation identifiers may be assigned different tasks within the food preparation workflow to enable food order subsets to be routed to the appropriate workstation.

As previously discussed, the target restaurant may be one of a plurality of available restaurants having diverse menus. In at least some examples, the target restaurant may be selected or otherwise identified by the customer via the customer interface. In other examples, the customer may select a subset of the available restaurants (e.g., a restaurant chain) via the customer interface to which the order is to be directed. If two or more of the available restaurants of the subset have identical or similar menus, and one or more of the other available restaurants have different menus, then the method at 218 may further include selecting the target restaurant as one of the two or more available restaurants of the subset based on one or more of: geographic proximity (e.g., the restaurant nearest to the delivery location), estimated travel time and/or delivery time for each restaurant, estimated preparation time for each restaurant, availability of the one or more menu items at each restaurant, and/or availability of inventory at each restaurant used or consumed to prepare the food order. This information may be stored in a restaurant profile for each restaurant where it may be accessed to select or suggest a target restaurant for a particular food order and/or customer.

At 220, the method may include updating a restaurant profile of the target restaurant to reflect the food order. As one example, the method at 220 may include decrementing an ingredient inventory stored in a restaurant profile of a database for the target restaurant responsive to receiving and/or processing the order. The one or more ingredients present in the one or more menu items may be decremented within the ingredient inventory to reflect their consumption or use in fulfilling the food order. The restaurant profile may also be updated to indicate the identity of the customer that initiated the order. The restaurant profile may be accessed via an order-fulfillment interface or via a dedicated restaurant management interface, for example.

At 222, the method may include estimating a preparation time for completing the food order. The preparation time may be estimated based, at least in part, on prior pending orders (e.g., an order queue) existing at the one or more workstations of the target restaurant. The indication of the estimated preparation time may be transmitted to one or more client devices over the communications network for presentation to the customer via the customer interface and/or to a delivery agent via a delivery-fulfillment interface.

At 224, the method may include estimating a delivery time for delivering the food order to the delivery location. The indication of the estimated delivery time may be transmitted to one or more client device over the communications network for presentation to the customer via the customer interface and/or to a delivery agent via a delivery fulfillment interface. The delivery time may be estimated based, at least in part, on one or more of the estimated preparation time, an estimated travel time between the target restaurant and the delivery location, a geographic location of a delivery agent relative to the delivery location and/or target restaurant, and/or a delivery queue existing at each delivery agent.

At 226, the method may include directing a delivery task to a client device of a delivery agent for presentation via a delivery-fulfillment interface. The delivery agent may be responsible for delivery of the food order to the delivery location. The delivery task may indicate one or more of the delivery location, a suggested delivery route, the estimated preparation time, the estimated delivery time, and/or an estimated travel time. The client device of the delivery agent may take the form of a workstation of the target restaurant or of a mobile wireless client device. Directing a delivery task to a mobile wireless client device may include transmitting the delivery task over a wireless communications network to the mobile wireless client device where it may be presented via the delivery fulfillment interface.

If the target restaurant is associated with a plurality of delivery agents, the method at 226 may include selecting the delivery agent from a plurality of available delivery agents. As one example, a delivery agent may be select based, at least in part, on prior pending deliveries assigned to the available delivery agents (e.g., a delivery queue) and/or geographic location of the available delivery agents relative to a geographic location of the target restaurant. A geographic location of a delivery agent may be identified by geo-location of a client device carried with the delivery agent. The method may further include receiving an indication of on-duty and/or off-duty states of a pool of delivery agents. The on-duty and/or off-duty states may be stored in delivery agent profiles for each delivery agent of the pool. Responsive to receiving the order and/or upon completion of preparation of the food order, the delivery agent profiles may be referenced to identify the available delivery agents as those associated with on-duty states. Delivery agent profiles may be updated at 228 to reflect the food orders and/or to indicate assignment of delivery tasks to delivery agents.

At 230, the method may include sharing contact information between a client device of the customer and a client device of the delivery agent and/or establishing a communication link between the client device of the customer and the client device of the delivery agent to enable voice or text communications between the customer and the delivery agent. Such communications may enable delivery agents to locate customers in order to complete delivery of the food order and/or to notify customers of late or early deliveries relative to the estimate delivery time. As one example, one or more of the customer interface and/or delivery-fulfillment interface may be updated to indicate the contact information of the other party.

At 232, the method may include receiving a delivery confirmation and/or financial transaction information from the delivery agent via the delivery-fulfillment interface. In at least some examples, the order received at 216 and/or the customer profile referenced at 214 may further indicate financial transaction information enabling the customer to be charged for fulfillment of the food order. As another example, financial transaction information may be received from the client device of the delivery agent via the delivery-fulfillment interface. The financial transaction information enables the customer to be charged for fulfillment of the food order and/or may indicate physical receipt of funds from the customer by the delivery agent.

The customer profile may be referenced to process subsequent orders initiated by the customer. For example, if a subsequent order is received over the communications network that identifies the customer, the method may include referencing the delivery location stored in the customer profile responsive to receiving the subsequent order. A subsequent delivery task for the subsequent order may be directed to the delivery agent used to deliver a previous food order, or to a different delivery agent responsible for delivery of the subsequent order to the delivery location. The subsequent delivery task may indicate the delivery location stored in the customer profile. As another example, previous food orders may be referenced from the customer profile of the customer. Responsive to a request received from the customer during a customer session, a recommendation may be transmitted to the client device of the customer over the communications network for presentation via the customer interface. The recommendation may indicate one or more recommended menu items based, at least in part, on the previous food orders stored in the customer profile.

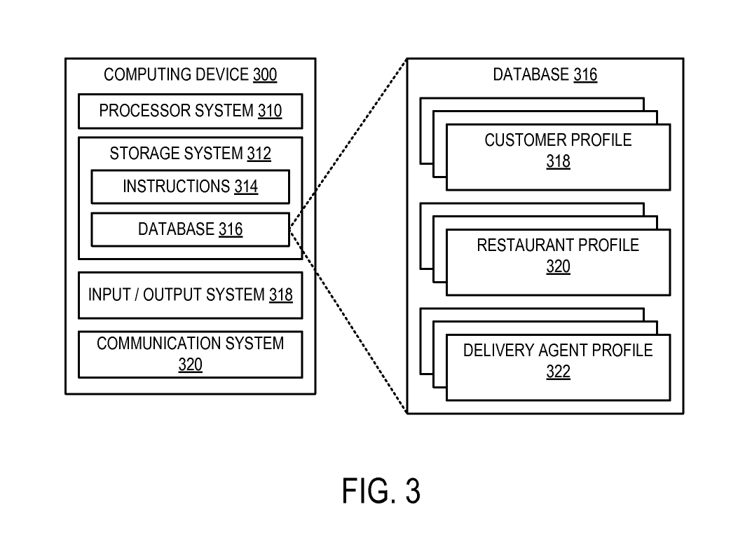

FIG. 3 is a schematic diagram depicting an example computing device 300. Computing device 300 may take the form of one or more of the previously described computing devices of FIG. 1. As one example, computing device 300 may take the form of a server device or server system used to implement some or all of method 200 of FIG. 2. As another example, computing device 300 may take the form of a client device or workstation used to present an interface, such as a customer interface, order fulfillment interface, or delivery-fulfillment interface depending on context.

Computing device 300 may include a processor system 310 including one or more processors, and a storage system 312 having instructions 314 and/or database 316 stored thereon. Instructions 314 may be executed by processor system 310 to perform one or more of the processes, methods, or operations described herein. Instructions 314 may take the form of software and/or firmware, including one or more of an operating system, a special purpose application program (e.g., a restaurant order processing application), or a multi-purpose application program (e.g., a web browser). In the context of a client device or workstation, an application program may be configured to present an interface as a graphical user interface, for example.

Computing device 300 may further include an input/output system 318 including one or more input devices (e.g., keyboard, keypad, mouse, pointing device, touch-screen, audio microphone, etc.) and/or one or more output devices (e.g., graphical display, touch-screen, audio speaker, etc.) enabling a human user to interact with the computing device. Input/output system 318 may include a credit card reader in some examples to enable a credit card to be read by the computing device to process financial information associated with the credit card. Computing device 300 may further include a communication system 320 that enables the computing device to communicate with other computing devices over a communications network by wired and/or wireless communications. The communications network may include one or more of a wide area network (e.g., the Internet), a local area network (e.g., an Intranet), and/or a personal area network.

Aspects of database 316 are shown in greater detail, including one or more customer profiles such as example customer profile 318, one or more restaurant profiles such as example restaurant profile 320, and one or more delivery agent profiles such as example delivery agent profile 322. Computing device 300 may distinguish between multiple customer profiles corresponding to multiple customers using customer identifiers. Computing device 300 may similarly distinguish between multiple restaurant profiles corresponding to multiple restaurants using restaurant identifiers. Restaurants owned or operated by a common entity and/or restaurants forming a restaurant group or chain may associated with each other in database 316 to enable identification of a subset of restaurant profiles belonging to the same restaurant group or chain. A restaurant profile may include or may otherwise be associated with one or more workstation identifiers in database 316. Computing device may distinguish between multiple delivery agent profiles corresponding to multiple delivery agents using delivery agent identifiers. A delivery agent may be associated with one or more restaurants within database 316. Customer profiles, restaurant profiles including individual workstations, and delivery agent profiles may be associated with contact information, such as telephone number, IP address, email address, etc. to enable or otherwise facilitate communication among computing devices operated by customers, restaurant staff, and delivery agents.

Use Case Scenario

The following use case scenario illustrates one example utilization of the above described systems and methods. A family living in a large metropolitan city is planning a birthday party for their 5 year old son. The son expresses an interest in having pizza and a cake decorated with a rocketship. It does not need to be stated that the parents are busy people, and thus they decide to order these items to be delivered to the party via an online ordering system at which they are preregistered. At noon on the day of the party, which is set to begin at 4 pm, the father uses his smartphone (wireless mobile client device 132) to access the online ordering portal of a pizza chain (server system 136). The online ordering portal presents a menu of pizza options based on the father's prior order history and location stored in his user profile, from which the father enters an order including 3 large pepperoni pizzas and 3 large Canadian bacon and pineapple pizzas for the children attending the party, and one large pear, walnut, and gorgonzola cheese pizza for the adults. The father also orders a chocolate cake with white vanilla frosting and a picture of a rocketship on top.

The online ordering portal identifies restaurant locations that can fulfill the order given the father's location, and estimates the preparation time and delivery time for the order based on the order queue at each of the restaurants, and then presents delivery time options to the father based on the “fastest available” preparation and delivery times retrieved. The father is relieved to find out that although the order is being placed at noon, the order can be delivered in two separate deliveries from two separate restaurants as early as 4 pm the same day. A first delivery from a first restaurant of the chain will include the pepperoni and Canadian bacon and pineapple pizzas. However, the first restaurant did not offer cake service and could not accommodate the pear, walnut, and gorgonzola cheese order as it did not have pears in inventory. Thus, the order will be split into two parts and a second party for the order consisting of the cake and pear, walnut and gorgonzola pizza will be prepared and delivered from a second restaurant of the pizza chain. This will work well for the father since the party is scheduled to begin at 5 pm. Thus, the father inputs a requested delivery time of 4 pm, and selects the pre-payment option via a payment card stored in his user profile.

The online ordering system directed a delivery task for each part of the order to a pool of delivery agents. As preparation of the order approached completion at each restaurant, the delivery agents determined that a single delivery agent could efficiently pick up each part of the order from each of the restaurants and deliver it by the 4 pm delivery time. Accordingly, the delivery tasks were consolidated. At 3:55 pm, the father began to get anxious about whether the order would actually be delivered on time, and pulled out his cell phone to check order status through the online ordering portal. The online order portal presented status of “en route” and an option to “contact delivery agent”. The father pressed this option, and was placed in telephone contact with the delivery agent, who indicated he was approaching the lobby of the father's building, and would soon be at their door with the order. In the end, the order was delivered at 3:58 pm, two minutes ahead of schedule, and a delivery confirmation was sent to the server system. Since prepayment was made, no money was collected, however the prepayment transaction was only entered into after confirmation of the delivery was received by the server system. The birthday party started on time, and all partygoers were well fed with pizza and cake.

As illustrated by this example use case scenario, the above described systems and methods may enable a user to order items for delivery from a restaurant or restaurant chain, and receive an accurate estimation of time of ultimate delivery based on an estimated preparation in view of prior pending orders, and a delivery time for delivering to the requested location. The system can also determine the most efficient restaurants locations to service an order based on items in inventory, order queues, location, and delivery agent availability, among other factors, and can split an order between restaurants and/or delivery agents if necessary to process it in time to meet a requested delivery time. Further a communications channel between the ordering party and the delivery agent is available, to enable the ordering party to get up to the minute status of the delivery.

The various configurations and/or techniques described herein are exemplary in nature. Disclosed implementations, embodiments, or examples are not to be considered in a limiting sense, because numerous variations are possible. The methods and/or processes described herein may represent one or more of any suitable number of processing strategies. The various methods and/or processes that have been described and/or depicted may be performed in the disclosed sequence, in other sequences, in parallel, or in some cases omitted. The subject matter of the present disclosure includes all novel and non-obvious combinations and sub-combinations of the various configurations and techniques, and other features, functions, acts, and/or properties disclosed herein, as well as any and all equivalents thereof.

1. A method for a computing system, comprising:
receiving an order over a communications network initiated by a customer via a client device, the order indicating a target restaurant of a plurality of available restaurants having diverse menus, a delivery location, and a food order including one or more menu items available at the target restaurant;
directing the food order to one or more workstations of the target restaurant for presentation via an order-fulfillment interface to staff responsible for preparation of the one or more menu items; and
directing a delivery task to a different client device for presentation via a delivery-fulfillment interface to a delivery agent responsible for delivery of the food order to the delivery location, the delivery task indicating the delivery location.

2. The method of claim 1, further comprising:
estimating a delivery time for delivering the food order to the delivery location; and
transmitting an indication of the estimated delivery time to the client device over the communications network for presentation to the customer.

3. The method of claim 2, further comprising:
estimating a preparation time for completing the food order based, at least in part, on prior pending orders existing at the one or more workstations;
wherein the delivery time is based, at least in part, on the estimated preparation time.

4. The method of claim 2, further comprising:
estimating a preparation time for completing the food order based, at least in part, on prior pending orders existing at the one or more workstations;
wherein the delivery task further indicates the estimated preparation time.

5. The method of claim 1, wherein the different client device is a workstation of the target restaurant; or
wherein the different client device is a mobile wireless client device, and wherein directing the delivery task includes transmitting the delivery task over a wireless communications network to the mobile wireless client device.

6. The method of claim 1, further comprising:
directing a first subset of the food order to a first workstation of the target restaurant responsible for preparation of a first food component of the one or more menu items; and
directing a second subset of the food order to a second workstation of the target restaurant responsible for preparation of a second food component of the one or more food items.

7. The method of claim 1, wherein the plurality of available restaurants includes at least two restaurants having an identical menu and at least one restaurant having a different menu from the at least two restaurants; and
wherein the method further comprises:
if the target restaurant is one of the at least two restaurants having the identical menu, selecting the target restaurant as one of the at least two restaurants that is nearest to the delivery location.

8. The method of claim 1, wherein the delivery task further indicates a suggested route to the delivery location.

9. The method of claim 1, wherein the delivery location is indicated by geo-location of the client device that initiated the order.

10. The method of claim 1, further comprising:
storing the delivery location in a customer profile of the customer;
receiving a subsequent order over the communications network, the subsequent order identifying the customer;
referencing the delivery location stored in the customer profile responsive to receiving a subsequent order from the customer identified by the subsequent order; and
directing a subsequent delivery task the delivery agent or a different delivery agent responsible for delivery of the subsequent order to the delivery location, the subsequent delivery task indicating the delivery location.

11. The method of claim 1, further comprising:
storing the food order in a customer profile of the customer;
receiving a request over the communications network, the request identifying the customer;
referencing the food order stored in the customer profile; and
responsive to the request, transmitting a recommendation over the communications network, the recommendation indicating one or more recommended menu items based, at least in part, on the food order stored in the customer profile.

12. The method of claim 1, further comprising:
selecting the delivery agent from a plurality of available delivery agents based, at least in part, on prior pending deliveries assigned to the available delivery agents and/or geographic location of the available delivery agents indicated by geo-location of client devices carried with the available delivery agents.

13. The method of claim 12, further comprising:
receiving an indication of on-duty and/or off-duty states of a pool of delivery agents;
storing the on-duty and/or off-duty states in delivery agent profiles for each delivery agent of the pool; and
responsive to receiving the order, referencing the delivery agent profiles to identify the available delivery agents as those associated with on-duty states.

14. The method of claim 1, further comprising:
identifying a geographic location of the delivery agent by geo-location of the different client device carried with the delivery agent; and
estimating a delivery time for delivering the food order to the delivery location based, at least in part, on the geographic location of the delivery agent relative to the delivery location; and
transmitting the indication of the estimated delivery time to the client device over the communications network for presentation to the customer.

15. The method of claim 1, further comprising:
decrementing an ingredient inventory stored in a restaurant profile of the target restaurant responsive to receiving the order, wherein one or more ingredients present in the one or more menu items are decremented within the ingredient inventory.

16. The method of claim 1, wherein the order further indicates financial transaction information enabling the customer to be charged for fulfillment of the food order.

17. The method of claim 1, further comprising:
receiving financial transaction information from the different client device via the delivery-fulfillment interface, the financial transaction information enabling the customer to be charged for fulfillment of the food order or indicating receipt of funds from the customer by the delivery agent.

18. The method of claim 1, further comprising:
sharing contact information between the client device and the different client device and/or establishing a communication link between the client device and the different client device to enable voice or text communications between the customer and the delivery agent.

19. A storage system having instructions stored thereon executable by a processor system to:
receive an order over a communications network initiated by a customer via a client device, the order indicating a delivery location and a food order including one or more menu items;
selecting a target restaurant from a plurality of available restaurants, the target restaurant having the one or more menu items available at the target restaurant, and the target restaurant selected based on proximity to the delivery location.
direct the food order to one or more workstations of the target restaurant for presentation via an order-fulfillment interface to staff responsible for preparation of the one or more menu items;
estimate a preparation time for completing the food order based, at least in part, on prior pending orders existing at the one or more workstations;
estimate a delivery time for delivering the food order to the delivery location, wherein the delivery time is based, at least in part, on the estimated preparation time;
transmit an indication of the estimated delivery time to the client device over the communications network for presentation to the customer;
and
direct a delivery task to a different client device for presentation via a delivery-fulfillment interface to a delivery agent responsible for delivery of the food order to the delivery location, the delivery task indicating the delivery location and the estimated preparation time.

20. A computing system, comprising:
one or more server devices configured to:
receive an order over a communications network initiated by a customer via a client device, the order indicating a target restaurant of a plurality of available restaurants having diverse menus, a delivery location, and a food order including one or more menu items available at the target restaurant;
direct the food order to one or more workstations of the target restaurant for presentation via an order-fulfillment interface to staff responsible for preparation of the one or more menu items;
direct a delivery task to a different client device for presentation via a delivery-fulfillment interface to a delivery agent responsible for delivery of the food order to the delivery location, the delivery task indicating the delivery location;
identify a geographic location of the delivery agent by geo-location of the different client device carried with the delivery agent;
estimate a delivery time for delivering the food order to the delivery location based, at least in part, on the geographic location of the delivery agent relative to the delivery location;
transmit the indication of the estimated delivery time to the client device over the communications network for presentation to the customer;
store the delivery location in a customer profile of the customer
associate an identifier of the delivery agent with the delivery location stored in the customer profile;
receive a subsequent order over the communications network, the subsequent order identifying the customer;
reference the delivery location stored in the customer profile responsive to receiving a subsequent order from the customer identified by the subsequent order; and
direct a subsequent delivery task the delivery agent indicated by the identifier associated with the delivery location for delivery of the subsequent order to the delivery location.
